(19) United States
(12) Patent Application Publication
(10) Pub. No.: US 2016/0248489 A1
(43) Pub. Date: Aug. 25, 2016

(54) CHANNEL STATE INFORMATION ACQUISITION AND FEEDBACK FOR FULL DIMENSION MULTIPLE INPUT MULTIPLE OUTPUT

(71) Applicant: NOKIA SOLUTIONS AND NETWORKS OY, Espoo (FI)

(72) Inventors: Weidong YANG, San Diego, CA (US); Jun TAN, Lake Zurich, IL (US)

(21) Appl. No.: 15/030,218

(22) PCT Filed: Sep. 25, 2014
(86) PCT No.: PCT/EP2014/070480

§ 371 Date: Apr. 18, 2016

Related U.S. Application Data
(63) Continuation of application No. 14/057,962, filed on Oct. 18, 2013, now abandoned.

(51) Int. Cl. H04B 7/04; H04B 7/06; H04L 25/02; H04L 5/00

(52) U.S. Cl. CPC H04B 7/0456; H04L 5/0048; H04B 7/0626; H04L 25/0224

(57) ABSTRACT

Various communication systems may benefit from feedback related to communication conditions. For example, certainly wireless communication systems may benefit from channel state information acquisition and feedback, particularly in connection with, for example, full dimension multiple input multiple output. A method can include configuring, at a base station, a plurality of reference signals as sampling points for channel state information. The method can also include restoring channel state information from implicit feedback information from a user equipment based on the sampling points. The method can further include selecting a precoder based on channel state information for a specific user equipment.

### BACKGROUND

1. Field

Various communication systems may benefit from feedback related to communication conditions. For example, certainly wireless communication systems may benefit from channel state information acquisition and feedback, particularly in connection with, for example, full dimension multiple input multiple output.

2. Description of the Related Art

Full-dimension multiple-input/multiple-output (MIMO) and three-dimensional (3D) beamforming are technologies that may be used in long term evolution (LTE) release 12 (Rel 12), millimeter wave (mmWave) transmission, and beyond. Full dimension MIMO (FD-MIMO) can use a large number of transmit/receive (Tx/Rx) receivers to enable high efficiency transmission for indoor/outdoor cellular communications. The significantly increased number of antennas of FD-MIMO may provide challenges for channel estimation and channel feedback.

As mentioned above, FD-MIMO is a technology that can use a large number of transmit (Tx) antennas at an evolved Node B (eNB) in multi-user MIMO (MU-MIMO) transmissions. FD-MIMO can take advantage of the quasi-orthogonality of spatial signatures of UEs, which can use approximated weights based on antenna-wise channel estimation.

FD-MIMO operation in one example can follow the following steps: first, identify the channel state information (CSI) of the FD-MIMO channel; and second, use or design the transmit weight for MU-MIMO. As the spatial signatures of UEs are close to being orthogonal, UE pairing may be a straightforward procedure.

Conventionally, CSI can be acquired in uplink sounding for time division duplex (TDD). By contrast, for frequency division duplex (FDD), MIMO is supported by the following: UE and eNB agree upon a codebook; UE observes CRS or CSI-RS in the downlink; and UE feeds back the preferred PMI.

LTE Rel-10 channel state indicator reference symbol (CSI-RS) in the downlink can be upper limited to 8 ports. If that paradigm is followed to support FD MIMO, increasing the number of CSI ports may be possible, for example, the CSI ports may be increased to 16. There may, however, be several related issues such as the following: extremely high codebook search complexity with 16 by v dimension, where v is the rank of the codeword; and CSI port overhead and cell planning issues.

Hence, it is not conventionally straightforward to support FD MIMO for FDD. Due to the issues highlighted above with FDD when a conventional feedback framework is used, FD-MIMO may be considered for TDD, where the CSI is acquired with uplink sounding. This approach has issues, including the following: uplink sounding is a TDD only solution to acquire CSI; and substantial calibration burden is put on the radio frequency (RF) system as now one has to put calibration circuit with densely arranged antennas.

UL sounding is a general approach for network to acquire CSI in a TDD system. However, as mentioned above, it may be limited to TDD systems, and it may impose a calibration burden.

For both TDD and FDD, in a conventional CSI feedback scheme, for example in LTE Rel-10, 8 CSI-RS ports are configured for an eight-port antenna system. Also, the complex valued channel gain from one eNB antenna to a UE antenna can be estimated at UE. The channel estimate of 8 antennas can be matched with the precoding matrix in the UE's codebook, potentially considering the non-whiteness of the spatial interference the UE experiences. The precoding matrix index (PMI) can be selected and feedback to the eNB. The framework works well when the number of antenna ports is limited, such as 8 antenna ports.

When the antenna number is large, for example 64 antennas with an 8×8 antenna array, a simple extension of that framework may require dividing antennas into multiple groups and using the existing CSI feedback framework on each antenna groups, not unlike the practice in CSI feedback for coordinated multipoint (CoMP) joint transmission (JT), then multiple CSI processes may be needed to feed back sub-channels (for example, 8×1 for each) and the co-phasing terms to piece together the sub-channels into a whole observation.

A quadrant method has been proposed. In essence, in this method cell splitting is used for CSI feedback. Moreover, PMI based feedback is assumed in the quadrant method proposal.

### SUMMARY

According to certain embodiments, a method can include configuring, at a base station, a plurality of reference signals as sampling points for channel state information. The method can also include restoring channel state information from feedback information from a user equipment based on the sampling points. The method can further include selecting a precoder based on channel state information for a specific user equipment.

In certain embodiments, a method can include computing an estimate of channel state information based on a limited number of samples at reference symbols. The method can also include performing at least one of explicitly feeding back the estimate to a base station; implicitly feeding back a succinct set of parameters identified in compressed sensing processing; or implicitly feeding back a succinct set of parameters extracted from a best precoder.

An apparatus, according to certain embodiments, can include at least one processor and at least one memory including computer program code. The at least one memory and the computer program code can be configured to, with the at least one processor, cause the apparatus at least to configure, at a base station, a plurality of reference signals as sampling points for channel state information. The at least one memory and the computer program code can also be configured to, with the at least one processor, cause the apparatus at least to restore channel state information from feedback information from a user equipment based on the sampling points. The at least one memory and the computer program code can further be configured to, with the at least one processor, cause the apparatus at least to select a precoder based on channel state information for a specific user equipment.

An apparatus, in certain embodiments, can include at least one processor and at least one memory including computer program code. The at least one memory and the computer program code can be configured to, with the at least one processor, cause the apparatus at least to compute an estimate of channel state information based on a limited number of samples at reference symbols. The at least one memory and the computer program code can be configured to, with the at least one processor, cause the apparatus at least to perform at least one of explicitly feeding back the estimate to a base station; implicitly feeding back a succinct set of parameters identified in compressed sensing processing; or implicitly feeding back a succinct set of parameters extracted from a best precoder.

According to certain embodiments, an apparatus can include means for configuring, at a base station, a plurality of reference signals as sampling points for channel state information. The apparatus can also include means for restoring channel state information from feedback information from a user equipment based on the sampling points. The apparatus can further include means for selecting a precoder based on channel state information for a specific user equipment.

In certain embodiments, an apparatus can include means for computing an estimate of channel state information based on a limited number of samples at reference symbols. The apparatus can also include means for performing at least one of explicitly feeding back the estimate to a base station; implicitly feeding back a succinct set of parameters identified in compressed sensing processing; or implicitly feeding back a succinct set of parameters extracted from a best precoder.

According to certain embodiments, a non-transitory computer-readable medium can be encoded with instructions that, when executed in hardware, perform a process. The process can include configuring, at a base station, a plurality of reference signals as sampling points for channel state information. The process can also include restoring channel state information from feedback information from a user equipment based on the sampling points. The process can further include selecting a precoder based on channel state information for a specific user equipment.

In certain embodiments, a non-transitory computer-readable medium can be encoded with instructions that, when executed in hardware, perform a process. The process can include computing an estimate of channel state information based on a limited number of samples at reference symbols. The process can also include performing at least one of explicitly feeding back the estimate to a base station; implicitly feeding back a succinct set of parameters identified in compressed sensing processing; or implicitly feeding back a succinct set of parameters extracted from a best precoder.

### BRIEF DESCRIPTION OF THE DRAWINGS

For proper understanding of the invention, reference should be made to the accompanying drawings, wherein:

FIG. 1 illustrates error performance of a channel state information acquisition method according to certain embodiments.

FIG. 2 illustrates loss in beamforming gain versus channel estimation error according to certain embodiments.

FIG. 3 illustrates a method according to certain embodiments.

FIG. 4 illustrates a system according to certain embodiments.

### DETAILED DESCRIPTION

In full dimension multiple-input, multiple-output (MIMO) systems, due to the large number of antennas present, channel state information (CSI) acquisition and CSI feedback can be challenging. Certain embodiments provide a reduced-complexity methodology and system that permit a user equipment (UE) to estimate and feed the channel response back to all transmit/receive (TX/RX) antennas based on a compressed sensing methodology.

Certain embodiments address the issues identified above for FD-MIMO and provide a solution to enable FD-MIMO for FDD and TDD. Some fundamental discussion may aid in understanding the principles of certain embodiments, although these examples and explanations are non-limiting.

Based on signal processing theory, a continuous time band limited signal can be sampled at evenly spaced intervals, and the original signal can be reconstructed from those discrete observations provided the sampling rate is greater than or equal to the Nyquist rate. As a continuous time band limited one dimensional (1-D) signal (f(t) =0,−∞<t<∞ being excluded) extends from −∞ to ∞, a windowing function W(t) can be applied to f(t), such that W(t)f(t) can be approximately of finite duration and can still be faithfully reconstructed with finite discrete samples.

If a two dimensional (2D) function is band limited, the Nyquist sampling theorem can be applied to guarantee that the 2D function can be faithfully reconstructed from finite samples. Similarly, one can use a 2D windowing function to bridge the math of sampling theorems and engineering practice.

For both 1D and 2D signals (functions), uneven sampling can also be used to reconstruct the signals. If f(t)=b(t)e^{jωt}, and the bandwidth of b(t) is B and ω>>B, then f(t) can be sampled at 2B , and f(t) can be reconstructed faithfully.

For FD-MIMO, the channel gains between densely packed eNB antennas may not be independent. Due to constraints at deployment, there may be a requirement on the form factor of the antenna panel. Hence, antennas of FD-MIMO may be densely packed. Consequently, the electromagnetic (EM) wave detected at the antennas may be correlated. Even when form factor is not a constraint, for example, the antennas may be spread over, from a 2D signal processing theory, the EM samples at receiver antennas, which are correlated. They may be structured and that structure can be exploited just as in the case of densely packed antennas.

To model the wave progression in the 3D space, the antenna's coordinates can be defined as (x, y, z). If a rectangle/square array is assumed to arrange antennas, then for antenna (m, n) where m is the row index and n is the column index, the antenna's coordinates can be given by (x, mΔy, nΔz) where Δy is the horizontal antenna spacing and Δz is the vertical antenna spacing. The coordinate system can be chosen so mechanical downtilt does not need to be explicitly accounted for. For simplicity, x=0.

If the impinging ray moves along the direction (aᵢ,bᵢ,cᵢ), then the received signal on antenna (m, n) can be given by

$${g}_{m , n} ( t ) = {\sum }_{i = 1}^{L} {e}^{j \frac{{a}_{i} x + {b}_{i} Δ ym + {c}_{i} Deltazm}{λ} 2 π}$$

$${α}_{i} δ ( t - {τ}_{i} ) = {\sum }_{i = 1}^{L} {α}_{i} {e}^{j ( {b}_{i} {d}_{y} m + {c}_{i} {d}_{y} zm ) 2 π} δ ( t - {τ}_{i} )$$

where αᵢ is the complex gain factor for each ray and τᵢ is delay associated with ray i,

$${d}_{y} = \frac{Δ y}{λ} , {d}_{z} = \frac{Δ z}{λ} .$$

On tone k, assuming a tone spacing of Δf such as 15 KHz in LTE, the complex channel gain can be given by

$${g}_{m , n , k} = {\sum }_{i = 1}^{L} {α}_{i} {e}^{j ( {b}_{i} {d}_{y} m + {c}_{i} {d}_{y} zm + {τ}_{i} Δ fk ) 2 π}$$

The richness of correlation in horizontal direction of arrival (DoA), vertical DoA, and time delay can be shown. For a single ray, xᵢ(t)=s₁(t), x₂(t)=s₁(t−τ), x₃(t)=s₁(t−2τ), . . . . For a narrow-band signal and antennas that are far away from the source so that a planar approximation is accurate, s₁(t)≈αe^{j2πf}^{_{c}}^{t}, s₁(t−τ)≈αe^{-j2πf}^{_{c}}^{(t-τ)}=s₁(t)e^{j2πf}^{_{c}}^{τ}, . . .

$$\begin{matrix}x ( t ) = [ \begin{matrix}{x}_{1} ( t ) \\ {x}_{2} ( t ) \\ ⋮ \\ {x}_{M} ( t )\end{matrix} ] \\ = [ \begin{matrix}{s}_{1} ( t ) \\ {s}_{1} ( t - τ ) \\ ⋮ \\ {s}_{1} ( t - ( M - 1 ) τ )\end{matrix} ] \\ \approx [ \begin{matrix}1 \\ {e}^{- j2π {f}_{c} τ} \\ ⋮ \\ {e}^{- j2π {f}_{c} ( M - 1 ) τ}\end{matrix} ] {s}_{1} ( t ) \\ = a ( {θ}_{1} ) {s}_{1} ( t )\end{matrix}$$

where τ=δ sin θ₁/c.

With multiple rays, by superposition, for d signals,

$$\begin{matrix}x ( t ) = a ( {θ}_{1} ) {s}_{1} ( t ) + … + a ( {θ}_{d} ) {s}_{d} ( t ) \\ = {\sum }_{k = 1}^{d} a ( {θ}_{k} ) {s}_{k} ( t ) .\end{matrix}$$

As a general model with noise,

$$\begin{matrix}x ( t ) = {\sum }_{k = 1}^{d} a ( {θ}_{k} ) {s}_{k} ( t ) + n ( t ) \\ = As ( t ) + n ( t )\end{matrix}$$

where A=[α(θ₁), . . . , α(θ_{d})] and s(t)=[s₁(t), . . . , s_{d}(t)]^{T}.

The impinging rays can be constrained to a limited angle. The antenna gain can decrease when the DoA is not in the bore sight, also the large back-to-front ratio achievable with modern antenna design can contribute to the success of this method.

The pulses in the elevation domain, horizontal domain, and timing domain may not be independent, rather they may be correlated and clustered. Thus, the Compressed Sensing (CS) theory may be a suitable tool to model channels in a succinct way.

In view of these and other considerations, certain embodiments can address both CSI acquisition and CSI feedback for FD-MIMO. FD-MIMO can involve a large number of Tx/Rx channels, as mentioned above. The CSI acquisition can a user equipment (UE) process to estimate all Tx/Rx channels, and CSI feedback can be a process to send back the acquired CSI from the UE to an evolved Node B (eNB).

For CSI acquisition, there may be at least two aspects. First, an eNB can be configured with sparse CSI-RS (S-CSI-RS) resource elements (REs) that can be used at predefined period or used in a one shot fashion, such as by being triggered by a physical uplink shared channel (PUSCH) downlink control indicator (DCI). Each configured S-CSI-RS RE can be energized by one or more antennas, where other antennas are muted on that RE. The mapping of antenna(s) to S-CSI-RS REs can be predefined according to parameters such as cell ID, or virtual cell ID, and/or the number of eNB antennas.

Various options are possible. For example, interfering cells can be configured with muting patterns so the interference from interfering cells can be reduced. For another example, there can be multiple configurations of the mapping between antenna(s) and S-CSI-RS REs, and the selection of one configuration out of those multiple configurations can be carried dynamically, for example by a PUSCH DCI.

In a further example, the following information on the mapping between antennas(s) and S-CSI-RS REs can be provided to UEs. First, the antenna configuration (1D horizontal, 1D vertical, 2D, 3D, and so on) at eNB can be further broadcasted to the UEs. Additionally, the polarization of the antennas can be identified to the UEs. The antennas can be put to different polarization groups and a data compaction scheme; alternatively a multiple field data can be used with each field for each antenna.

According to a second aspect, on the UE side, a UE can observe S-CSI-RS REs at a fixed period or as triggered by the eNB. The triggering may be, for example, through PUSCH DCI. Sampling based on Compressed Sensing (CS) theory can be performed on the observed S-CSI-RS REs so the channel estimates for all antennas at all frequency tones, at all symbol times are obtained at the UE. The details of the sampling for CSI acquisition is discussed below.

A best precoder, which constitutes the complex gain at each antenna, each tone, each symbol time, can be derived from the obtained channel estimates. The best precoder may just be or be derived from the conjugate of the channel estimates. A pseudo-random sampling pattern (PRSP) can determine the complex gains at what REs at what antennas are kept. The PRSP can either be configured by network or derived by the UE from the information provided by the eNB.

For CSI feedback, the UE can feed CSI towards the network. The CSI may be one or more of the following. For example, the CSI can include S-CSI-RS RE observations. In this case, the CSI acquisition method can be performed at the eNB and the UE does not need to implement the CSI acquisition method.

In another example, the CSI can include a succinct set of parameters identified in the CS processing. Thus, a reconstruction of the channel estimate may be possible at the eNB once the eNB obtains those parameters, which of course assumes the recovering basis/frame in CS processing is shared between UE and eNB.

In a further example, the CSI can include a succinct set of parameters extracted from the best precoder. Thus, a reconstruction of the identified best precoder can be possible at the eNB once the eNB obtains those parameters. This option may assume that the recovering basis/frame in CS processing is shared between UE and eNB.

The network can use the CSI in one of the following ways depending on nature of CSI feedback. For example, the channel estimate can be reconstructed by the eNB with the CS processing. The best precoder can be designed by the eNB. Alternatively, the best precoder can be reconstructed by the eNB with the CS processing.

Conventionally in the LTE design, feedback approaches can be categorized as implicit feedback approaches or explicit feedback approaches. In explicit feedback, a UE can send back to the eNB network a description of the channel. The description can include eigenvectors, quantized channel coefficients, and the like. In implicit feedback, a UE can send the information on the preferred precoders back to the eNB network.

For explicit and implicit feedbacks, the feedback information can be carried in a digitized fashion or in an analog fashion. Thus, in this discussion there is no assumption on the association of {analog, digital} vs. {implicit, explicit}. For the reason of UE testability, LTE has been following the implicit feedback paradigm.

When CSI feedback is designed based on the CS principle, there are at least two possible approaches. In one approach, it is assumed that explicit feedback is used. Thus, a concise description of the wireless channel is developed at the UE and sent to the network. In another approach, it is assumed that the implicit feedback is used. Then, the description of the preferred precoders can be sent to the network. Here, the term precoding matrix index (PMI) can be avoided, so as to avoid the appearance that the number of precoders is small enough to be enumerated.

As mentioned above, sampling for CSI acquisition can be based on the Compressed Sensing (CS) theory. Mathematically, the received signal can be described as rₖ=HPₖ+nₖ, where k=1, . . . , K, rₖ can be the received signal for the k -th recorded signal, nₖ can be the noise, Pₖ can be an MN×1 precoder, and H can be a 1×MN vector for the channel gains between eNB antennas and one UE antenna.

If the elements of H are all independent, then K≧MN may be needed. Thus, in this case the approach can rely on solving for H.

On the other hand, if H's elements are not independent, and if the basis functions/vectors Q can be properly chosen so that H is presented as C_{H}Q, where Q is a L×MN matrix, C_{H} (a 1×L vector) is a succinct capture of H with basis vectors Q. This will yield

rₖ=C_{H}QPₖ+n,

permitting K≧L to suffice to solve for H.

One challenge is to find the 1×MN-dimension channel H, with K number of rₖ, where

rₖ=HPₖ+zₖ.

The K numbers of channel precoder Pₖ may be known. The challenge may be to find the channel H with larger dimension with fewer samples of rₖ.

Based on the compressive sampling theory, it may be desirable to measure all the MN coefficients of H. By contrast, an observation of K samples rₖ, k=1, . . . , K may be available. With this information, it can be decided to recover the signal H by l₁-norm minimization. Accordingly, a reconstruction Ĥ can be given by

Ĥ−\hat{x}Ψ,

where \hat{x} is the solution to the convex optimization program:

min_{xεR}_{^{MN}}∥x∥ₗ_{₁}

subject to,

rₖ=xΨPₖ.

Note that

$${‖ x ‖}_{{l}_{1}} = {\sum }_{l}^{ } \vert {x}_{l} \vert .$$

Based on the compressive sensing theory, for a fixed H, if the coefficient sequence x in the basis Ψ is S-sparse, and the K-samples are uniformly random in the Φ domain, then the estimation can be perfect when noise is absent.

An eNB can configure the CSI reference symbol (S-CSI-RS) REs, which are served as sampling points to estimate CSI at a UE side. The UE can receive K number of samples rₖ, as defined in the previous discussion. The UE or eNB, which may receive explicit feedback from the UE, can estimate the CSI as the 1×MN-dimension channel H. The acquisition algorithm can estimate H with MN values when the actual sampling points K<<MN. Some detailed steps to achieve this include the following. First a Fourier operator Ψ can be used. The system can then find the corresponding elements for the given k=1, . . . , K. Next, linear programming can be used to solve the convex problem: min_{xεR}_{^{MN}}∥x∥ₗ_{₁}, subject to rₖ=xΨPₖ, for all k. The solution can be \hat{x}=argminₓ∥x∥ₗ_{₁}. Finally, the solution \hat{x} can be used to calculate the estimated channel as Ĥ=\hat{x}Ψ. The estimated channel Ĥ can be the acquired CSI for the UE, based on the K number of samples rₖ.

As mentioned above, certain embodiments can include CSI acquisition and CSI feedback. The CSI acquisition can include eNB configuration on S-CSI-RS for possible sampling at UE. CSI acquisition can also include a CSI acquisition method based on sampling at reference symbols (S-CSI-RS). The CSI feedback can involve the preparation of a UE for either explicit feedback or implicit feedback. The implicit feedback can also need the eNB to recover the CSI from “succinct” information provided by a UE.

An eNB can use the following operations in connection with certain embodiments. First, the eNB can configure reference symbols (for example, S-CSI-RS) as sampling points for CSI based on the respective requirements. Next, the eNB can restore CSI based on a CSI acquisition method from implicit feedback information from a UE. Finally, the eNB can select a precoder based on explicit/implicit CSI information for a specific UE.

A UE can use the following operations in connection with certain embodiments. First, the UE can compute to estimate the CSI based on a limited number of samples at reference symbols, using a CSI acquisition method described herein. The UE can also explicitly feedback the estimated CSI to the eNB. The UE can further implicitly feedback a succinct set of parameters identified in the CS processing so a reconstruction of the channel estimate may be possible at the eNB. The succinct set may be much shorter than a complete, exhaustive set. Moreover, the UE can implicitly feedback a succinct set of parameters extracted from the best precoder so a reconstruction of the identified best precoder is possible at eNB.

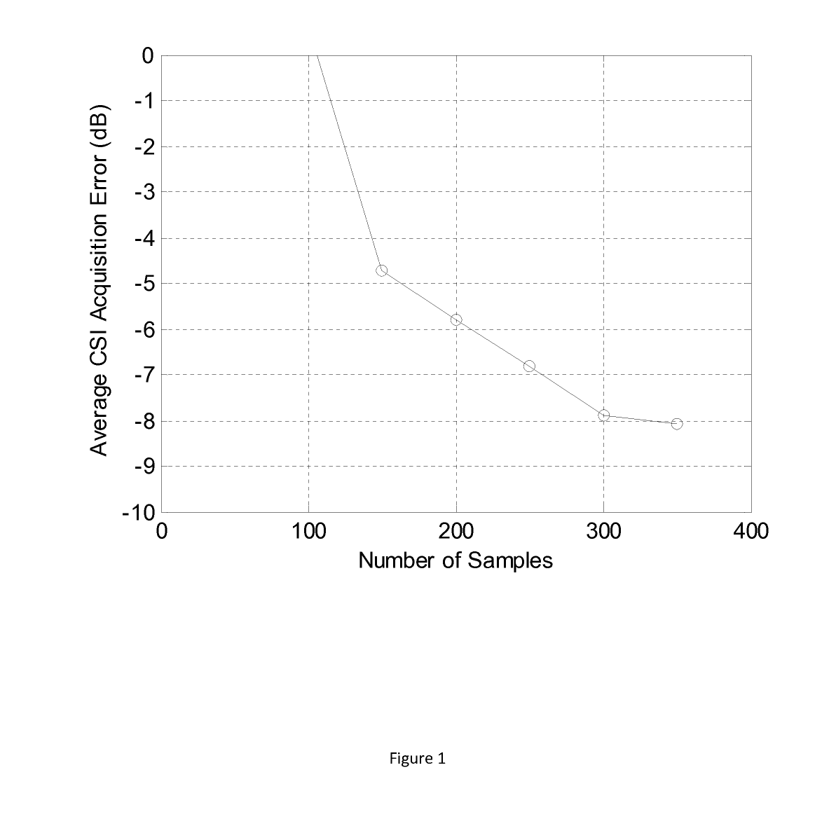

FIG. 1 illustrates error performance of a CSI acquisition method. More particularly, one simulation result based on the new CSI acquisition method is shown in FIG. 1. It shows the error performance for the CSI acquisition method over multiple numbers of samples. The channel responses for 64 antennas can be estimated over 50 physical resource blocks (PRBs). The 64 antennas can be arranged as a matrix of 8×8 antennas. The same antenna polarity can be assumed for all antennas. As shown above, for cross-polarized antennas, the succinct description for one polarity may share some common parameters with that for another polarity. Considering the fact that the compression ratio is so high, an example is provided here with antennas of the same polarity.

To demonstrate the channel estimation algorithm and corresponding performance, 3 tones per PRB can be checked, and 150 tones can be provided for comparison. The total number of REs to be estimated can be 64×50=9600. If 150 samples (S-CSI-RS REs) are used (overhead may be 150 REs over 50 PRBs), the achieved average CSI acquisition error can be about −4.8 dB. When the number of S-CSI-RE is increased to 300, which is about 300/9600=3.1% overhead, the average CSI error can be about −8 dB, referring to the signal power. In this example, the new CSI acquisition method can provide good CSI estimation with a low S-CSI-RS overhead.

As a comparison, for the 8 port CSI-RS configuration, 8 REs per PRB can be used. Over 50 PRBs, 400 REs can be reserved for CSI feedback. The example provided shows with roughly the same RE overhead, the channel can be estimated for 64 Tx antennas.

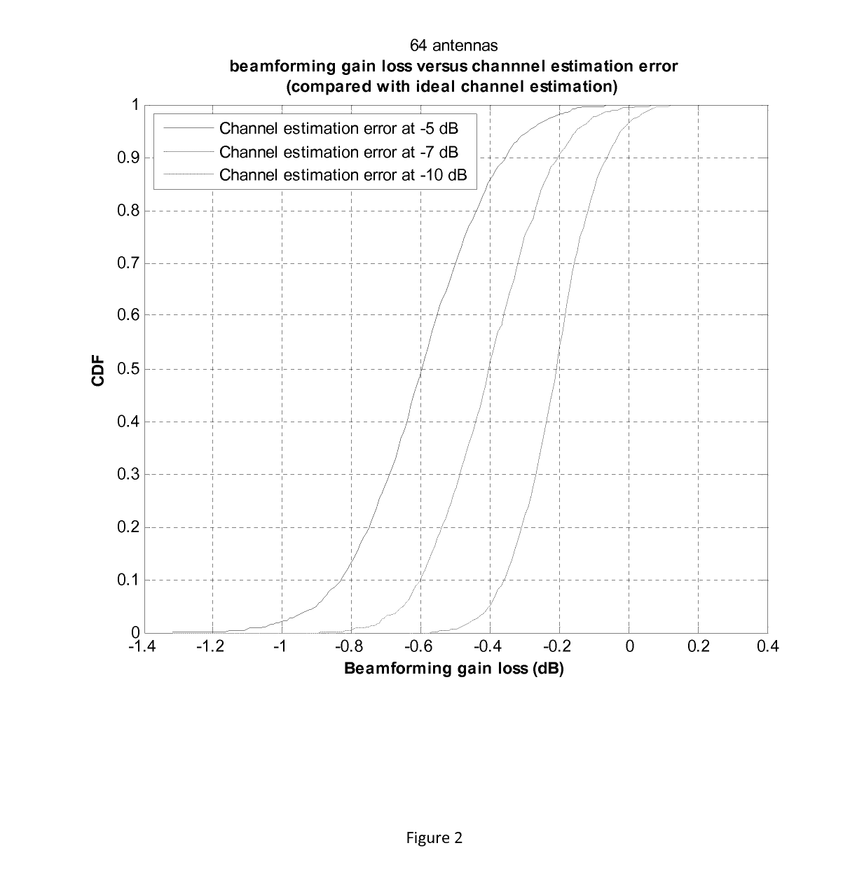

FIG. 2 illustrates loss in beamforming gain versus channel estimation error. From FIG. 2 it can be seen that the CSI acquisition does not need to be perfect to provide useful beamforming gain.

Moreover, FIG. 1 shows that the CSI acquisition error of the new method can be as low as −5 dB with ˜150 sampling points and as low as ˜−8 dB with 300 sampling points. Compared with the configuration with 8 port CSI-RS introduced in LTE Rel-10, the number of CSI-RS REs can be 400 over 50 PRBs. The method of certain embodiments, therefore, can provide good performance with a lower overhead for 64 antenna ports.

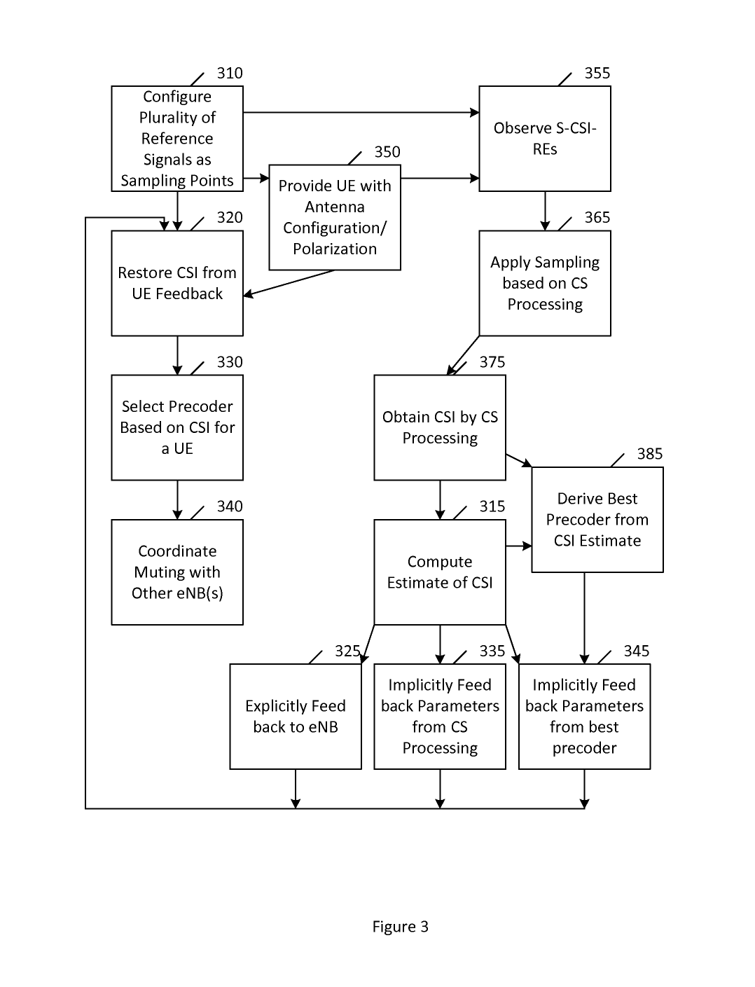

FIG. 3 illustrates a method according to certain embodiments. As shown in FIG. 3, a method can include, at 310, configuring, at a base station, a plurality of reference signals as sampling points for channel state information. The configuration of the plurality of reference signals can include mapping at least one antenna to at least one sparse channel state indicator resource element. The mapping can involve selecting one mapping from a plurality of preconfigured mappings.

The method can also include, at 320, restoring channel state information from feedback information from a user equipment based on the sampling points. The restoration of channel state information can include the base station reconstructing a channel estimate with compressed sensing processing. The method can further include, at 330, selecting a precoder based on channel state information for a specific user equipment.

Moreover, the method can include, at 340, coordinating a muting pattern between the base station and at least one other base station. A best precoder can be designed by the base station. Alternatively, selection of the precoder can include the base station reconstructing a best precoder using compressed sensing processing.

The method can also include, at 350, providing to the user equipment at least one of an antenna configuration of the base station or an antenna polarization of the base station.

The above portion of the method can be performed by, for example, a a base station such as an evolved Node B. The following portion of the method may be performed by, for example, a user equipment such as a mobile phone or other terminal device.

The method can include, at 315, computing an estimate of channel state information based on a limited number of samples at reference symbols. The method can also include performing at least one of, at 325 explicitly feeding back the estimate to a base station; at 335 implicitly feeding back a succinct set of parameters identified in compressed sensing processing; or 345 implicitly feeding back a succinct set of parameters extracted from a best precoder.

The method can also include, at 355, observing sparse channel state information resource elements. Moreover, the method can include, at 365, applying a sampling based on compressed sensing to the observed resource elements. Furthermore, the method can include, at 375, obtaining channel state estimates from samples obtained by the compressed sensing, which may correspond as well to the computing an estimate of CSI at 315.

At 385, the method can include deriving a best precoder from the channel state estimates. The best precoder can, in some cases, be a conjugate of the channel state estimates. A pseudo-random sampling pattern can determine complex gains at which resource elements at which antennas are kept. The pseudo-random sampling pattern can either be configured by the base station or can be derived by the user equipment from information provided by the base station.

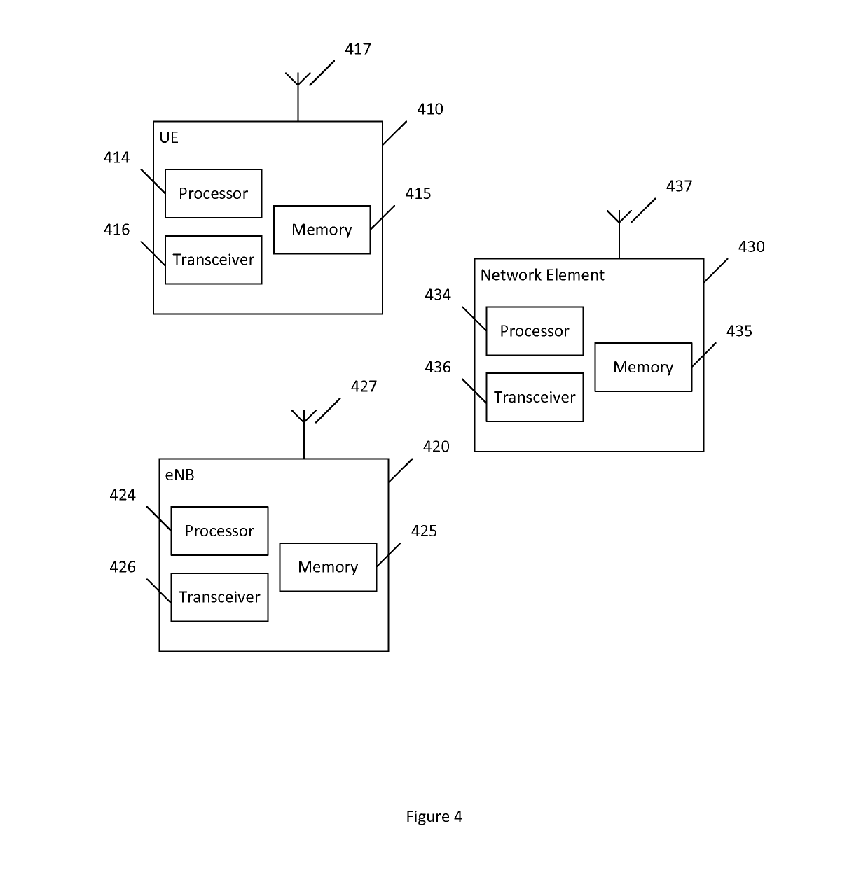

FIG. 4 illustrates a system according to certain embodiments of the invention. In one embodiment, a system may include multiple devices, such as, for example, at least one UE 410, at least one eNB 420 or other base station or access point, such as a Node B (NB), controller, or other similar network element of a radio access network, and at least one network element 430. In certain systems, a plurality of other user equipment and eNBs may be present, and the at least one network element 430 can correspond to one of these. Alternatively, the eNB 420 can be the eNB of a small cell and the network element 430 can be the eNB of a macro cell. Other configurations are also possible. The UE 410 can be any terminal device, such as a cell phone, a smart phone, a personal digital assistant, a tabletop computer, a personal computer, a laptop computer, a mini-tablet computer, a tablet computer, or the like.

Each of these devices may include at least one processor, respectively indicated as 414, 424, and 434. At least one memory can be provided in each device, as indicated at 415, 425, and 435, respectively. The memory may include computer program instructions or computer code contained therein. The processors 414, 424, and 434 and memories 415, 425, and 435, or a subset thereof, can be configured to provide means corresponding to the various blocks of FIG. 3. Although not shown, the devices may also include positioning hardware, such as global positioning system (GPS) or micro electrical mechanical system (MEMS) hardware, which can be used to determine a location of the device. Other sensors are also permitted and can be included to determine location, elevation, orientation, and so forth, such as barometers, compasses, and the like.

As shown in FIG. 4, transceivers 416, 426, and 436 can be provided, and each device may also include at least one antenna, respectively illustrated as 417, 427, and 437. The device may have many antennas, such as an array of antennas configured for multiple input multiple output (MIMO) communications, or multiple antennas for multiple radio access technologies. Other configurations of these devices, for example, may be provided. For example, network element 430 may be configured to communicate using wired communications, rather than having an antenna for communicating wirelessly and in such a case antenna 437 would illustrate any form of communication hardware, without requiring a conventional antenna. The communication can be, for example, via optical cables, or whatever transmission, such as microwave transmission or anything that is already deployed at operator side. Thus, the antenna 437 is merely illustrative of one example of the many forms of communication hardware that the network element 430 may have, if desired.

Transceivers 416, 426, and 436 can each, independently, be a transmitter, a receiver, or both a transmitter and a receiver, or a unit or device that is configured both for transmission and reception.

Processors 414, 424, and 434 can be embodied by any computational or data processing device, such as a central processing unit (CPU), application specific integrated circuit (ASIC), or comparable device. The processors can be implemented as a single controller, or a plurality of controllers or processors.

Memories 415, 425, and 435 can independently be any suitable storage device, such as a non-transitory computer-readable medium. A hard disk drive (HDD), random access memory (RAM), flash memory, or other suitable memory can be used. The memories can be combined on a single integrated circuit as the processor, or may be separate from the one or more processors. Furthermore, the computer program instructions stored in the memory and which may be processed by the processors can be any suitable form of computer program code, for example, a compiled or interpreted computer program written in any suitable programming language.

The memory and the computer program instructions can be configured, with the processor for the particular device, to cause a hardware apparatus such as UE 410, eNB 420, and network element 430, to perform any of the processes described above (see, for example, FIG. 3). Therefore, in certain embodiments, a non-transitory computer-readable medium can be encoded with computer instructions that, when executed in hardware, perform a process such as one of the processes described herein. Alternatively, certain embodiments of the invention can be performed entirely in hardware.

Furthermore, although FIG. 4 illustrates a system including a UE, eNB, and network element, embodiments of the invention may be applicable to other configurations, and configurations involving additional elements.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

### GLOSSARY

1-D One Dimension

2D Two Dimension

3D Three Dimension

3GPP Third Generation Partnership Project

ASIC Application Specific Integrated Circuit

CoMP JT Coordinated Multipoint Joint Transmission

CPU Central Processing Unit

CRS Cell-specific Reference Signal

CS Compressed Sensing/Compressive Sensing

CSI Channel State Information

CSI-RS Channel State Information Reference Signal

DoA Direction of Arrival

DCI Downlink Control Indicator

eNB Evolved Node B

EM Electromagnetic

FDD Frequency Division Duplex

FD-MIMO Full Dimension MIMO

HDD Hard Disk Drive

LTE Long Term Evolution of 3GPP

MIMO Multiple-Input Multiple-Output

mmWave Millimeter Wave

MU-MIMO Multi-User MIMO

PMI Precoding Matrix Index

PRB Physical Resource Block

PRSP Pseudo-Random Sampling Pattern

PUSCH Physical Uplink Shared Channel

RAM Random Access Memory

RE Resource Element

RF Radio Frequency

Rel Release

ROM Read Only Memory

Rx Receive/Reception

S-CSI-RS sparse CSI-RS

TDD Time Division Duplex

Tx Transmit/Transmission

UE User Equipment

We claim:

1. A method, comprising:
configuring, at a base station, a plurality of reference signals as sampling points for channel state information;
restoring channel state information from feedback information from a user equipment based on the sampling points; and
selecting a precoder based on channel state information for a specific user equipment.

2. The method of claim 1, further comprising:
coordinating a muting pattern between the base station and at least one other base station.

3. The method of claim 1, wherein configuration of the plurality of reference signals includes mapping at least one antenna to at least one sparse channel state indicator resource element.

4. The method of claim 3, wherein the mapping comprises selecting one mapping from a plurality of preconfigured mappings.

5. The method of claim 1, further comprising:
providing to the user equipment at least one of an antenna configuration of the base station or an antenna polarization of the base station.

6. The method of claim 1, wherein restoration of channel state information includes the base station reconstructing a channel estimate with compressed sensing processing, wherein a best precoder is designed by the base station.

7. The method of claim 1, wherein selection of the precoder comprises the base station reconstructing a best precoder using compressed sensing processing.

8. A method, comprising:
computing an estimate of channel state information based on a limited number of samples at reference symbols; and
performing at least one of
explicitly feeding back the estimate to a base station;
implicitly feeding back a succinct set of parameters identified in compressed sensing processing; or
implicitly feeding back a succinct set of parameters extracted from a best precoder.

9. The method of claim 8, further comprising:
observing sparse channel state information resource elements;
applying a sampling based on compressed sensing to the observed resource elements; and
obtaining channel state estimates from samples obtained by the compressed sensing.

10. The method of claim 9, further comprising:
deriving a best precoder from the channel state estimates.

11. The method of claim 10, wherein the best precoder comprises a conjugate of the channel state estimates.

12. The method of claim 9, wherein a pseudo-random sampling pattern determines complex gains at which resource elements at which antennas are kept.

13. The method of claim 12, wherein the pseudo-random sampling pattern is either configured by the base station or is derived by the user equipment from information provided by the base station.

14. An apparatus, comprising:
at least one processor; and
at least one memory including computer program code,
wherein the at least one memory and the computer program code are configured to, with the at least one processor, cause the apparatus at least to
configure, at a base station, a plurality of reference signals as sampling points for channel state information;
restore channel state information from feedback information from a user equipment based on the sampling points; and
select a precoder based on channel state information for a specific user equipment.

15. The apparatus of claim 14, wherein, in configuration of the plurality of reference signals, the at least one memory and the computer program code are configured to, with the at least one processor, cause the apparatus at least to map at least one antenna to at least one sparse channel state indicator resource element.

16. The apparatus of claim 14, wherein, in restoration of channel state information, the at least one memory and the computer program code are configured to, with the at least one processor, cause the apparatus at least to reconstruct a channel estimate with compressed sensing processing, wherein a best precoder is designed by the base station.

17. The apparatus of claim 14, wherein, in selection of the precoder, the at least one memory and the computer program code are configured to, with the at least one processor, cause the apparatus at least to reconstruct a best precoder using compressed sensing processing.

18. An apparatus, comprising:
at least one processor; and
at least one memory including computer program code,
wherein the at least one memory and the computer program code are configured to, with the at least one processor, cause the apparatus at least to
computing an estimate of channel state information based on a limited number of samples at reference symbols; and
performing at least one of
explicitly feeding back the estimate to a base station;
implicitly feeding back a succinct set of parameters identified in compressed sensing processing; or
implicitly feeding back a succinct set of parameters extracted from a best precoder.

19. The apparatus of claim 18, wherein the at least one memory and the computer program code are configured to, with the at least one processor, cause the apparatus at least to:
observe sparse channel state information resource elements;
apply a sampling based on compressed sensing to the observed resource elements; and
obtain channel state estimates from samples obtained by the compressed sensing.

20. The apparatus of claim 19, wherein the at least one memory and the computer program code are configured to, with the at least one processor, cause the apparatus at least to derive a best precoder from the channel state estimates.
